(19) United States
(12) Patent Application Publication
(10) Pub. No.: US 2019/0363595 A1
(43) Pub. Date: Nov. 28, 2019

(54) ROTOR AND MOTOR USING SAME

(71) Applicant: Nidec Corporation, Kyoto (JP)

(72) Inventor: Tomoya UEDA, Kyoto (JP)

(21) Appl. No.: 16/469,687

(22) PCT Filed: Jan. 12, 2018
(86) PCT No.: PCT/JP2018/000627

§ 371 Date: Jun. 14, 2019

(30) Foreign Application Priority Data
Jan. 20, 2017 (JP) 2017-008445

(51) Int. Cl. H02K 1/27; H02K 1/02; H02K 21/16

(52) U.S. Cl. CPC H02K 1/2766; H02K 29/03; H02K 21/16; H02K 1/02

(57) ABSTRACT

A rotor includes a cylindrical rotor core including salient pole portions on an outer circumferential surface and extending along a central axis and magnetic pole portions each including a rotor magnet and alternately arranged with the salient pole portions in a circumferential direction of the rotor core on the outer circumferential surface or a radially inner side of the rotor core. The salient pole portions and the magnetic pole portions correspond to magnetic poles of the rotor. In a cross-section perpendicular to the central axis, the salient pole portions and the magnetic pole portions include salient pole outer circumferential surfaces in an arc shape and a magnetic pole outer circumferential surfaces in an arc shape protruding radially outward.

### CROSS REFERENCE TO RELATED APPLICATIONS

This is the U.S. national stage of PCT Application No. PCT/JP2018/000627, filed on Jan. 12, 2018, and priority under 35 U.S.C. § 119(a) and 35 U.S.C. § 365(b) is claimed from Japanese Application No. 2017-008445, filed Jan. 20, 2017; the entire disclosures of which are incorporated herein by reference.

### FIELD OF THE INVENTION

The present disclosure relates to a rotor and a motor including the same.

### BACKGROUND

In related art, a configuration including a rotor core and a rotor magnet has been known as a rotor used for a motor. In recent years, a configuration of the rotor in which the amount of use of the rotor magnet is reduced because of a rise in the price of the rotor magnet due to a rise in a price of the rare earth has been studied. Conventionally, for example, a consequent-pole motor using a part of the rotor core as a pseudo pole has been known as a motor in which the amount of use of the rotor magnet is reduced.

In general, in the consequent-pole motor using a part of the rotor core as a pseudo pole, imbalance of magnetic characteristics between respective magnetic poles is large, as compared to a general motor in which all magnetic poles are rotor magnets. That is, in the rotor of the consequent-pole motor, since the part of the rotor core is used as a magnetic pole, magnetic imbalance occurs between a magnetic pole configured with the rotor magnet and a magnetic pole configured with the part of the rotor core. In this way, when magnetic imbalance occurs in the rotor, torque ripple (fluctuation in torque generated when the motor is energized) is generated in the motor.

In the consequent-pole motor, the reason why the magnetic imbalance occurs in the respective magnetic poles is as follows.

Since the magnetic pole configured with the part (a salient pole portion) of the rotor core does not have a compelling force for inducing a magnetic flux, the magnetic flux occurring on a rear surface of the rotor magnet flows through a part of the rotor core, which has low magnetic resistance. Thus, the magnetic flux may not equally flow through a plurality of salient pole portions depending on the shape of the salient pole portion of the rotor core. That is, since a direction and the amount of the magnetic flux flowing through the salient pole portions of the rotor core depend on the shapes of the salient pole portions, the rotor is magnetically unbalanced.

In contrast, conventionally, it has been known as a configuration in which an outer surface of a salient pole of a rotor core is formed to have a larger curvature (a radius of curvature smaller) than a circumference connecting outer surfaces of magnets and is gradually separated from a stator as the outer surface of the salient pole goes from a circumferential central portion toward an end portion of the outer surface.

In detail, in the conventional configuration, a cross section of the outer surface of the salient pole of the rotor core has an arc shape in which the protruding length of the central portion in the circumferential direction is large and the protruding length decreases toward the end portion in the circumferential direction.

However, conventionally, even when a cross section of a salient pole (a salient pole portion) of the rotor core has an arc shape, a difference occurs between the magnetic flux density of the magnetic flux interlinked with a stator coil from the magnetic pole portion of the rotor and the magnetic flux density of the magnetic flux interlinked with the stator coil from the salient pole portion of the rotor. Therefore, in the above-described configuration, magnetic imbalance occurs between the magnetic pole portion of the rotor and the stator coil and between the salient pole portion of the rotor and the stator coil. In a state in which such magnetic imbalance occurs, when the rotor rotates, waveforms of reverse voltages generated in the stator coil may not coincide with each other in some cases. When the waveforms of the reverse voltages generated in the stator coils are different from each other as described above, the torque ripple is generated in the motor.

### SUMMARY

A rotor according to an example embodiment of the present disclosure is a rotor including a rotor core in a cylindrical shape that includes a plurality of salient pole portions protruding in a radial direction and extends along a central axis, and a plurality of magnetic pole portions each including a rotor magnet and alternately arranged with the salient pole portions in a circumferential direction of the rotor core on a surface or a radially inner side of the rotor core. The salient pole portions correspond to one magnetic pole of the rotor. The magnetic pole portions correspond to another magnetic pole of the rotor. Each of the salient pole portions includes, in a cross section perpendicular to the central axis, a salient pole outer surface in an arc shape protruding in the radial direction. Each of the magnetic pole portions includes, in the cross section, a magnetic pole outer surface in an arc shape protruding in the radial direction. The salient pole outer surface includes, in the cross section, a radius of curvature larger than a radius of curvature of the magnetic pole outer surface.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a schematic configuration of a motor according to an example embodiment of the present invention.

FIG. 2 is a diagram illustrating an example of an arrangement of a stator coil according to an example embodiment of the present invention.

FIG. 3 is a diagram illustrating a connection state of the stator coil.

FIG. 4 is a partially enlarged view illustrating a motor according to an example embodiment of the present invention.

FIG. 5 is a diagram illustrating an example of a waveform of a reverse voltage generated in the stator coil when a rotor rotates in a case where a radius of curvature of a salient pole outer circumferential surface is the same as a radius of curvature of a magnetic pole outer circumferential surface of a magnetic pole portion, in a salient pole portion of the rotor.

FIG. 6 is a diagram illustrating an example of a waveform of a reverse voltage generated in the stator coil when a rotor rotates in a case where the radius of curvature of the salient pole outer circumferential surface is larger than the radius of curvature of the magnetic pole outer circumferential surface of the magnetic pole portion, in the salient pole portion of the rotor.

FIG. 7 is a diagram illustrating an example of a waveform of a reverse voltage generated in the stator coil when a rotor rotates in a case where a salient pole tapered portion is not provided in the salient pole portion of the rotor.

FIG. 8 is a diagram corresponding to FIG. 4 in the case of an IPM motor.

### DETAILED DESCRIPTION

Hereinafter, example embodiments of the present disclosure will be described in detail with reference to the drawings. The same or corresponding components in the drawings are denoted by the same reference numerals, and description thereof will not be repeated. Further, the dimensions of constituent members in each drawing do not reliably represent the actual dimensions of the constituent members and the dimensional ratios of the constituent members.

In the following description, a direction that is parallel to a central axis of a rotor is referred to as an “axial direction”, a direction that is perpendicular to the central axis of the rotor is referred to as a “radial direction”, and a direction along a circular arc with the central axis as a center is referred to as a “circumferential direction”. However, the definition of the directions is not intended to limit directions of the rotor and a motor according to the present disclosure at a time of use.

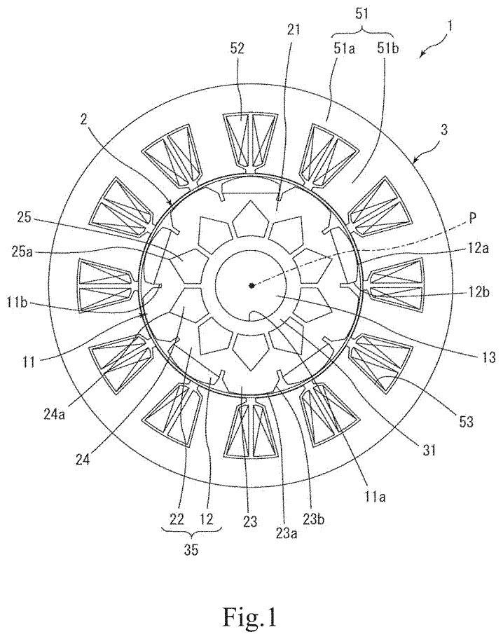

FIG. 1 illustrates a schematic configuration of a motor 1 according to an example embodiment of the present disclosure. The motor 1 includes a rotor 2 and a stator 3. As will be described later, the motor 1 is a so-called consequent-pole motor in which a part of a magnetic pole of the rotor 2 is configured with a rotor core 11. In the motor 1, the rotor 2 rotates about a central axis P with respect to the stator 3. In the present example embodiment, the motor 1 is an inner rotor type motor in which the columnar rotor 2 is rotatably disposed inside the cylindrical stator 3.

The rotor 2 includes the rotor core 11, a rotor magnet 12, and a rotary shaft 13.

The rotor core 11 has a cylindrical shape extending along the central axis P. The rotor core 11 is formed by laminating a plurality of electromagnetic steel plates formed in a predetermined shape in a thickness direction.

The rotor core 11 has a core portion 21 and a ring portion 31. The core portion 21 and the ring portion 31 have cylindrical shapes. The ring portion 31 extends along the central axis P, and has a through-hole 11a which the rotary shaft 13 penetrates. That is, the rotary shaft 13 is disposed inside the through-hole 11a. The through-hole 11a penetrates the rotor core 11 in an axial direction. The ring portion 31 has an annular cross section connected in a circumferential direction of the rotor core 11. The ring portion 31 is located further radially inward of the rotor core 11 than the first space 24 and the second space 25 provided in the core portion 21.

The core portion 21 has a cylindrical shape extending along the central axis P and located radially outward of the ring portion 31. That is, the core portion 21 is disposed concentrically with the ring portion 31. The core portion 21 and the ring portion 31 are formed integrally to constitute the rotor core 11.

The core portion 21 has a plurality of rotor magnet attaching units 22 and a plurality of salient pole portions 23 on an outer circumferential surface. The plurality of rotor magnet attaching units 22 and the plurality of salient pole portions 23 protrude radially outward from the core portion 21. The rotor magnet attaching units 22 and the salient pole portions 23 are alternately arranged in a circumferential direction of the core portion 21, that is, in the circumferential direction of the rotor core 11.

The rotor magnet 12 is fixed to the rotor magnet attaching unit 22. In detail, the rotor magnet attaching unit 22 protrudes radially outward of the core portion 21, and a tip end portion of the rotor magnet attaching unit 22 has a planar shape. The rotor magnet 12 is fixed to a tip end portion of the rotor magnet attaching unit 22. That is, the motor 1 according to the present example embodiment is a so-called surface permanent magnet (SPM) motor in which the rotor magnet 12 is disposed on an outer circumferential surface (a surface) of the rotor core 11. The rotor magnet 12 and the rotor magnet attaching unit 22 of the core portion 21 constitute a magnetic pole portion 35. The magnetic pole portion 35 protrudes from a radially outer side of the core portion 21. The magnetic pole portion 35 is the other magnetic pole of the rotor 2.

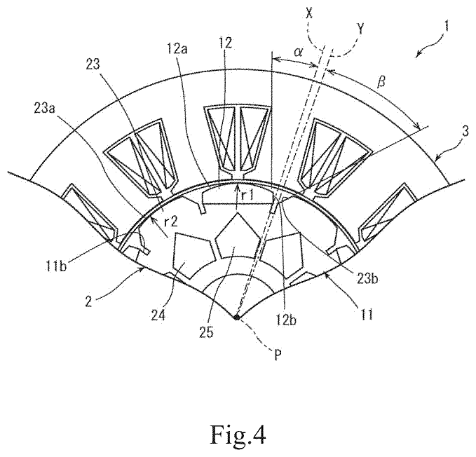

The rotor magnet 12 is a neodymium sintered magnet. That is, the rotor magnet 12 includes neodymium. In the cross section perpendicular to the central axis P, the rotor magnet 12 has an arc-shaped magnetic pole outer circumferential surface 12a (a magnetic pole outer surface) protruding from an outer side of the rotor core 11 in the radial direction. That is, the magnetic pole portion 35 has an arc-shaped magnetic pole outer circumferential surface 12a protruding radially outward, in the cross section. In the cross section, a radius r1 of curvature of the magnetic pole outer circumferential surface 12a is smaller than a radius r2 of curvature of the salient pole outer circumferential surface 23a (a salient pole outer surface) of the salient pole portion 23, which will be described below (see FIG. 4).

As illustrated in FIGS. 1 and 4, in the cross section, the rotor magnet 12 has magnetic pole tapered portions 12b at both end portions of the rotor core 11 in the circumferential direction, in which the outer surfaces of the rotor magnet 12 are inclined radially inward (on a base end side of the magnetic pole portion 35) of the rotor core 11 as it goes from a center to an outer side of the rotor magnet 12 in the circumferential direction. The base end side of the magnetic pole portion 35 means a portion on a side of the core portion 21 in the magnetic pole portion 35 protruding radially outward from the core portion 21.

As illustrated in FIG. 4, in the cross section perpendicular to the central axis P, the magnetic pole tapered portion 12b is inclined at an angle α with respect to a reference line X passing through an outer end (a portion located on an outermost side in the circumferential direction) of the magnetic pole portion 35 in the circumferential direction and extending radially from the rotor core 11.

As illustrated in FIGS. 1 and 4, the salient pole portion 23 has salient pole tapered portions 23b at both end portions of the rotor core 11 in the circumferential direction, in which in the cross section perpendicular to the central axis P, outer circumferential surfaces 23a (outer surfaces) of the salient pole portion 23 are linearly inclined radially inward (on a base end side of the salient pole portion 23) of the rotor core 11 as it goes from a center to an outer side of the salient pole portion 23 in the circumferential direction. That is, the salient pole portion 23 has a tapered shape in which as a tip end portion located radially outward of the rotor core 11 goes radially outward, the length in a circumferential direction becomes smaller. Detailed configurations of the salient pole portion 23 will be described below. The salient pole portion 23 is one magnetic pole of the rotor 2. A base end side of the salient pole portion 23 means a portion on a side of the core portion 21 in the salient pole portion 23 protruding radially outward from the core portion 21.

That is, the rotor 2 has a plurality of magnetic pole portions 35 and a plurality of salient pole portions 23 functioning as magnetic poles, respectively. The magnetic pole portion 35 and the salient pole portion 23 are alternately arranged in the circumferential direction of the rotor core 11. The rotor 2 according to the present example embodiment has 10 magnetic poles.

A slit 11b is configured between the rotor magnet attaching unit 22 and the salient pole portion 23 in the circumferential direction of the rotor core 11.

The rotor core 11 has a plurality of first spaces 24 and a plurality of second spaces 25 surrounded by the core portion 21. The plurality of first spaces 24 and the plurality of second spaces 25 penetrate the cylindrical core portion 21 in an axial direction. That is, the plurality of first spaces 24 and the plurality of second spaces 25 are partitioned by a part of the core portion 21. Each first space 24 and each second space 25 is a space having a pentagonal shape in a cross section perpendicular to the central axis P. The plurality of first spaces 24 and the plurality of second spaces 25 are alternately arranged in the circumferential direction of the rotor core 11 at regular intervals.

The first space 24 is located radially inward of the core portion 21 with respect to the salient pole portion 23 in the cross section perpendicular to the central axis P of the rotor core 11. The first space 24 has a pentagonal shape in which a vertex 24a is located radially inward of the core portion 21 with respect to a central portion of the salient pole portion 23 in the circumferential direction of the core portion 21 in the cross section.

The second space 25 is located radially inward of the core portion 21 with respect to the rotor magnet 12 in the cross section perpendicular to the central axis P of the rotor core 11. The second space 25 has a pentagonal shape in which a vertex 25a is located radially inward of the core portion 21 with respect to a central portion of the rotor magnet 12 in the circumferential direction of the core portion 21 in the cross section.

That is, in the first space 24 and the second space 25, in the cross section perpendicular to the central axis P of the rotor core 11, the vertexes 24a and 25a are located radially outward of the rotor core 11 in the first space 24 and the second space 25.

In the present example embodiment, the first space 24 and the second space 25 have the same shape and the same size in the cross section perpendicular to the central axis P of the rotor core 11. Further, as described above, the plurality of first spaces 24 and the plurality of second spaces 25 are alternately arranged in the circumferential direction of the rotor core 11 at regular intervals. That is, in the plurality of first spaces 24 and the plurality of second spaces 25, in the cross section, a center of the first space 24 in the circumferential direction of the rotor core 11 and a center of the second space 25 in the circumferential direction of the rotor core 11 are arranged in the circumferential direction of the rotor core 11 at regular intervals.

In the cross section perpendicular to the central axis P of the rotor core 11, an outer end of the first space 24 and an outer end of the second space 25 in the radial direction of the rotor core 11 are located at the same position in the radial direction. Here, the outer ends of the first space 24 and the second space 25 in the radial direction of the rotor core 11 mean outermost portions in the radial direction of the rotor core 11, that is, the vertexes 24a and 25a.

The position in the radial direction means a position of the rotor core 11 in the radial direction when the central axis P is used as a reference, in the cross section perpendicular to the central axis P of the rotor core 11. That is, the same position in the radial direction means the same distance from the central axis P in the radial direction of the rotor core 11 in the cross section.

Here, each of the first space 24 and the second space 25 has an air layer. Since the air layer has lower magnetic permeability than the rotor core 11, the flow of the magnetic flux is hindered by the first space 24 and the second space 25. The first space 24 and the second space 25 do not necessarily have air, and may be any area that has a larger magnetic resistance than the other portions in the rotor core 11. For example, substances other than the air may exist in the space.

The stator 3 has a cylindrical shape. The rotor 2 is disposed inside the stator 3 to be rotatable about the central axis P. That is, the stator 3 is disposed to face the rotor 2 in the radial direction. The stator 3 includes a stator core 51 and a plurality of stator coils (coils) 52. The stator core 51 has a cylindrical yoke 51a and a plurality of (in the present example embodiment, 12) teeth 51b extending radially inward from an inner surface of the yoke 51a, in a cross section that is perpendicular to the central axis P. The stator core 51 has slots 53 between the adjacent teeth 51b, respectively. The stator coils 52 are wound on the plurality of teeth 51b, respectively. That is, the stator coils 52 wound on the teeth 51b are positioned inside the plurality of slots 53. The number of the slots according to the present example embodiment is 12.

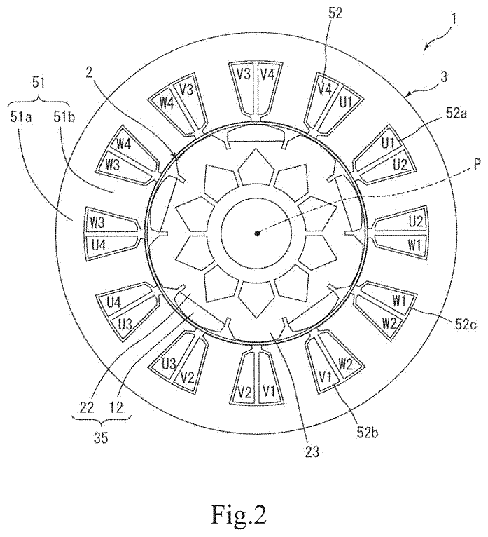

In FIG. 2, a state in which the stator coils 52 are wound on the teeth 51b of the stator core 51 is schematically illustrated. The stator coils 52 wound on the plurality of teeth 51b function as stator cores of each phase of the motor 1. In detail, the stator coils 52 include U-phase stator coils 52a (in FIG. 2, U1 to U4), V-phase stator coils 52b (in FIG. 2, V1 to V4), and W-phase stator coils 52c (in FIG. 2, W1 to W4). As illustrated in FIG. 2, the U-phase stator coils 52a, the V-phase stator coils 52b, and the W-phase stator coils 52c are wound on the plurality of teeth 51b of the stator core 51 in an order of the U-phase stator coils 52a, the V-phase stator coils 52b, and the W-phase stator coils 52c.

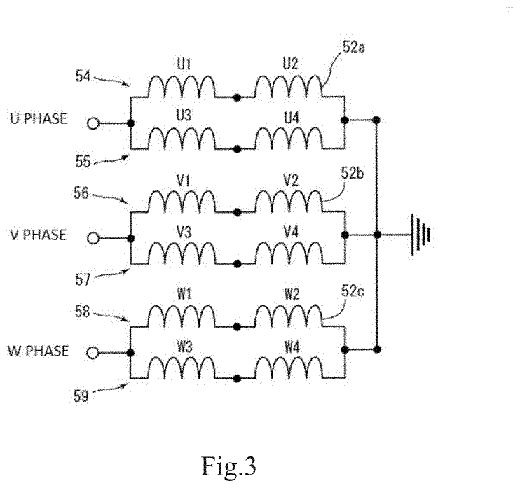

In the present example embodiment, the U-phase stator coils 52a are wound on four teeth 51b among the plurality of teeth 51b of the stator core 51, respectively. The U-phase stator coils 52a wound on the teeth 51b are indicated by U1, U2, U3, and U4 in FIGS. 2 and 3, respectively. FIG. 3 is a diagram schematically illustrating connection of the stator coil 52.

As illustrated in FIG. 2, U1 and U2 are disposed in the circumferential direction of the stator 2, in the cross section perpendicular to the central axis P of the stator 2. That is, U1 and U2 are configured with stator coils 52a wound on the adjacent teeth 51b in the circumferential direction of the stator 2. U3 and U4 are disposed in the circumferential direction of the stator 2 in the cross section. That is, U3 and U4 are configured with stator coils 52a wound on the adjacent teeth 51b in the circumferential direction of the stator 2. U1 and U3 are located on radially opposite sides of the stator 2 with the central axis P interposed therebetween, in the cross section. U2 and U4 are located on radially opposite sides of the stator 2 with the central axis P interposed therebetween, in the cross section. As illustrated in FIG. 3, U1 and U2 are connected in series to each other. U3 and U4 are connected in series to each other. The U-phase in-phase coil group 54 is configured with U1 and U2. The U-phase in-phase coil group 55 is configured with U3 and U4. The U-phase in-phase coil group 54 and the U-phase in-phase coil group 55 are connected in parallel to each other.

The V-phase stator coils 52b are wound on four teeth 51b among the plurality of teeth 51b of the stator core 51, respectively. The V-phase stator coils 52b wound on the teeth 51b are indicated by V1, V2, V3, and V4 in FIGS. 2 and 3, respectively.

As illustrated in FIG. 2, V1 and V2 are disposed in the circumferential direction of the stator 2, in the cross section perpendicular to the central axis P of the stator 2. That is, V1 and V2 are configured with the stator coils 52b wound on the adjacent teeth 51b in the circumferential direction of the stator 2. V3 and V4 are disposed in the circumferential direction of the stator 2 in the cross section. That is, V3 and V4 are configured with the stator coils 52b wound on the adjacent teeth 51b in the circumferential direction of the stator 2. V1 and V3 are located on radially opposite sides of the stator 2 with the central axis P interposed therebetween, in the cross section. V2 and V4 are located on radially opposite sides of the stator 2 with the central axis P interposed therebetween, in the cross section. As illustrated in FIG. 3, V1 and V2 are connected in series to each other. V3 and V4 are connected in series to each other. The V-phase in-phase coil group 56 is configured with V1 and V2. The V-phase in-phase coil group 57 is configured with V3 and V4. The V-phase in-phase coil group 56 and the V-phase in-phase coil group 57 are connected in parallel to each other.

The W-phase stator coils 52c are wound on four teeth 51b among the plurality of teeth 51b of the stator core 51, respectively. The W-phase stator coils 52c wound on the teeth 51b are indicated by W1, W2, W3, and W4 in FIGS. 2 and 3, respectively.

As illustrated in FIG. 2, W1 and W2 are disposed in the circumferential direction of the stator 2, in the cross section perpendicular to the central axis P of the stator 2. That is, W1 and W2 are configured with the stator coils 52c wound on the adjacent teeth 51b in the circumferential direction of the stator 2. W3 and W4 are disposed in the circumferential direction of the stator 2 in the cross section. That is, W3 and W4 are configured with the stator coils 52c wound on the adjacent teeth 51b in the circumferential direction of the stator 2. W1 and W3 are located on radially opposite sides of the stator 2 with the central axis P interposed therebetween, in the cross section. W2 and W4 are located on radially opposite sides of the stator 2 with the central axis P interposed therebetween, in the cross section. As illustrated in FIG. 3, W1 and W2 are connected in series to each other. W3 and W4 are connected in series to each other. The W-phase in-phase coil group 58 is configured with W1 and W2. The W-phase in-phase coil group 59 is configured with W3 and W4. The W-phase in-phase coil group 58 and the W-phase in-phase coil group 59 are connected in parallel to each other.

In the present example embodiment, in the stator coils 52a, 52b, and 52c, a winding direction of U1, U4, V1, V4, W2, and W3 with respect to the teeth 51b is opposite to a winding direction of U2, U3, V2, V3, W1, and W4 with respect to the teeth 51b, when viewed from tip ends of the teeth 51b. That is, in the stator coils 52a, 52b, and 52c, when U1, U4, V1, V4, W2, and W3 are wound on the teeth 51b in a clockwise direction when viewed from the tip ends of the teeth 51b, U2, U3, V2, V3, W1, and W4 are wound on the teeth 51b in a counterclockwise direction when viewed from the tip ends of the teeth 51b. Further, in the stator coils 52a, 52b, and 52c, when U1, U4, V1, V4, W2, and W3 are wound on the teeth 51b in a counterclockwise direction when viewed from the tip ends of the teeth 51b, U2, U3, V2, V3, W1, and W4 are wound on the teeth 51b in a clockwise direction when viewed from the tip ends of the teeth 51b.

When a positional relationship between the rotor 2 and the stator 3 is illustrated in FIG. 2, U1 of the U-phase in-phase coil group 54 faces the salient pole portion 23 of the rotor core 11 in the radial direction of the rotor core 11. Meanwhile, U3 of the U-phase in-phase coil group 55 faces the rotor magnet 12 of the rotor 2 in the radial direction. Further, U2 of the U-phase in-phase coil group 54 faces the rotor magnet 12 of the rotor core 11 in the radial direction of the rotor core 11. Meanwhile, U4 of the U-phase in-phase coil group 55 faces the salient pole portion 23 of the rotor core 11 in the radial direction.

Further, in FIG. 2, V1 and V2 of the V-phase in-phase coil group 56 and V3 and V4 of the V-phase in-phase coil group 57 face a part of the salient pole portion 23 and a part of the rotor magnet 12 in the radial direction of the rotor core 11.

Further, in FIG. 2, W2 of the W-phase in-phase coil group 58 faces the rotor magnet 12 of the rotor 2 in the radial direction of the rotor core 11. Meanwhile, W4 of the W-phase in-phase coil group 59 faces the salient pole portion 23 of the rotor core 11 in the radial direction. Further, W1 of the W-phase in-phase coil group 58 faces the salient pole portion 23 of the rotor core 11 in the radial direction of the rotor core 11. Meanwhile, W3 of the W-phase in-phase coil group 59 faces the rotor magnet 12 of the rotor 2 in the radial direction.

Next, a configuration of the salient pole portion 23 of the rotor core 11 will be described in detail with reference to FIGS. 1 and 4.

As illustrated in FIGS. 1 and 4, the salient pole portion 23 has an arc-shaped outer circumferential surface 23a (a salient pole outer surface) protruding radially outward of the rotor core 11 in the cross section perpendicular to the central axis P. The radius r2 of curvature of the salient pole outer circumferential surface 23a of the salient pole portion 23 is larger than the radius r1 of curvature of the magnetic pole outer circumferential surface 12a of the magnetic pole portion 35. In the radius r2 of curvature of the salient pole outer circumferential surface 23a, r1<r2<2×r1 may be satisfied. For example, the radius of curvature of the salient pole outer circumferential surface 23a is 16 mm, and the radius of curvature of the magnetic pole outer circumferential surface 12a is 12 mm.

Further, in the circumferential direction of the rotor core 11, the length of the salient pole outer circumferential surface 23a is larger than the length of the magnetic pole outer circumferential surface 12a.

As the salient pole outer circumferential surface 23 is configured as described above, a wider range of the salient pole outer circumferential surface 23 can be brought closer to the stator coil 52.

The salient pole portion 23 has salient pole tapered portions 23b at both end portions of the rotor core 11 in the circumferential direction, in which in the cross section perpendicular to the central axis P, the outer surfaces of the salient pole portion 23 are linearly inclined radially inward of the rotor core 11 as the salient pole portion 23 goes from a center to an outer side in the circumferential direction. As the salient pole tapered portion 23b is provided in the salient pole portion 23, an interval in the circumferential direction between the salient pole portion 23 and the rotor magnet 12 located next to the salient pole portion 23 in the circumferential direction becomes larger as the salient pole portion 23 and the rotor magnet 12 go toward the outside in the radial direction. The salient pole tapered portion 23b has planar surfaces provided on both end portions of the salient pole portion 23 in the circumferential direction and on an outer circumferential side in the radial direction.

As illustrated in FIG. 4, in the cross section perpendicular to the central axis P, the salient pole tapered portion 23b is inclined at an angle β with respect to a reference line Y passing through an outer end (a portion located on an outermost side in the circumferential direction) of the salient pole portion 23 in the circumferential direction and extending radially from the rotor core 11. The angle β of the salient pole tapered portion 23b is larger than the angle α of the magnetic pole tapered portion 12b provided in the rotor magnet 12. That is, an inclination of the salient pole tapered portion 23b with respect to the reference line Y is larger than an inclination of the magnetic pole tapered portion 12b with respect to the reference line X.

Here, as already described, in the motor 1 according to the present example embodiment, when the rotor 2 and the stator 3 is in the positional relationship illustrated in FIG. 2, in the U-phase in-phase coil group 55, the V-phase in-phase coil groups 56 and 57, and the W-phase in-phase coil group 58, in the radial direction of the rotor core 11, U1, U4, W1, and W4 mainly face the salient pole portion 23 of the rotor 2, and U2, U3, W2, and W4 mainly face the rotor magnet 12.

Therefore, when the magnetic fluxes generated in the rotor magnet 12 and the salient pole portion 23 are different from each other, for example, when the rotor 2 rotates in a clockwise direction in FIG. 2, a reverse voltage generated in the U-phase in-phase coil group 54 penetrating the rotor magnet 12 and the salient pole portion 23 in an order of the rotor magnet 12 and the salient pole portion 23 with respect to U2 differs from a reverse voltage generated in the U-phase in-phase coil group 55 penetrating the salient pole portion 23 and the rotor magnet 12 in an order of the salient pole portion 23 and the rotor magnet 12 with respect to U4. Similarly, when the rotor 2 rotates in a clockwise direction in FIG. 2, a reverse voltage generated in the V-phase in-phase coil group 56 penetrating the salient pole portion 23 and the rotor magnet 12 in the order of the salient pole portion 23 and the rotor magnet 12 with respect to V2 differs from a reverse voltage generated in the V-phase in-phase coil group 57 penetrating the rotor magnet 12 and the salient pole portion 23 in the order of the rotor magnet 12 and the salient pole portion 23 with respect to V4. Similarly, when the rotor 2 rotates in a clockwise direction in FIG. 2, a reverse voltage generated in the V-phase in-phase coil group 58 penetrating the rotor magnet 12 and the salient pole portion 23 in the order of the rotor magnet 12 and the salient pole portion 23 with respect to W2 differs from a reverse voltage generated in the W-phase in-phase coil group 59 penetrating the salient pole portion 23 and the rotor magnet 12 in the order of the salient pole portion 23 and the rotor magnet 12 with respect to W4.

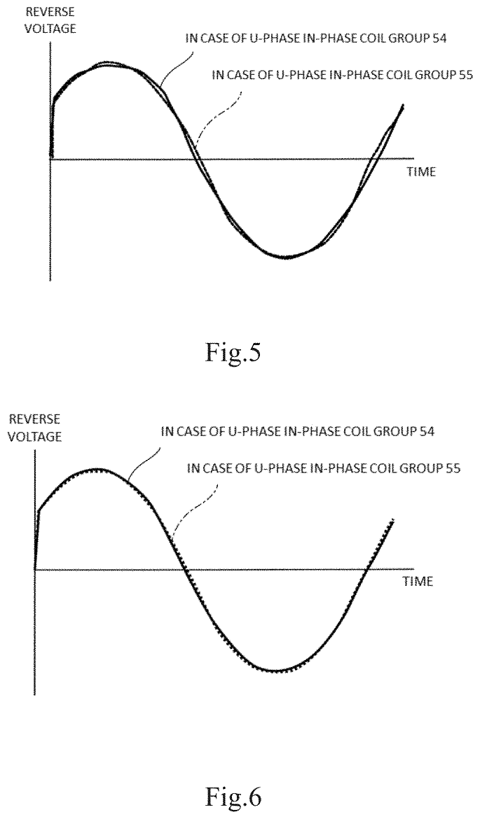

An example of a waveform of the reverse voltage in this case is schematically illustrated in FIG. 5. FIG. 5 is a diagram illustrating the reverse voltage generated in the stator coil 52a when the rotor 2 rotates in the U-phase in-phase coil groups 54 and 55. FIG. 5 is a result obtained when the radius of curvature of the salient pole outer circumferential surface 23a of the salient pole portion 23 is equal to the radius of curvature of the magnetic pole outer circumferential surface 12a of the magnetic pole portion 35. Further, the salient pole tapered portion 23b is provided in the salient pole portion 23, and the magnetic pole tapered portion 12b is provided in the rotor magnet 12. Although the U phase has been described as an example in the present example embodiment, the V phase and the W phase are the same as the U phase.

As illustrated in FIG. 5, a waveform (a broken line of the drawing) of the reverse voltage generated in the U-phase in-phase coil group 55 is different from a waveform (a solid line of the drawing) of the reverse voltage generated in the U-phase in-phase coil group 54.

As illustrated in FIG. 5, when the waveform of the reverse voltage differs between the in-phase coil groups 54 and 55 having the same coils, a circulating current flows in circuits of the in-phase coil groups 54 and 55 connected in parallel to each other. Then, the torque ripple (a fluctuation in a torque occurring when the motor is energized) is generated in the motor 2.

In contrast, as described above, as the radius of curvature of the salient pole outer circumferential surface 23a of the salient pole portion 23 is larger than the radius of curvature of the magnetic pole outer circumferential surface 12a of the magnetic pole portion 35, since a distance between the salient pole outer circumferential surface 23a and the stator coil 52 becomes short, the magnetic flux density of the magnetic flux interlinked with the stator coil 52 from the salient pole portion 23 increases. Accordingly, it is possible to reduce a difference between the magnetic flux density of the magnetic flux interlinked with the stator coil 52 from the salient pole portion 23 and the magnetic flux density interlinked with the stator coil 52 from the rotor magnet 12. Thus, it is possible to reduce magnetic imbalance generated between the salient pole portion 23 of the rotor 2 and the stator coil 52 and between the rotor magnet 12 and the stator coil 52.

FIG. 6 illustrates a waveform of the reverse voltage generated in the stator coil 52a when the rotor 2 rotates in the U-phase in-phase coil groups 54 and 55, in a configuration of the present example embodiment.

As illustrated in FIG. 6, as the configuration of the present example embodiment is applied, a deviation between the waveform (a broken line in the drawing) of the reverse voltage generated in the U-phase in-phase coil group 55 and the waveform (a solid line in the drawing) of the reverse voltage generated in the U-phase in-phase coil group 54 is reduced. As described above, it is considered that as a difference between the magnetic flux density of the magnetic flux interlinked with the stator coil 52 from the salient pole portion 23 and the magnetic flux density interlinked with the stator coil 52 from the rotor magnet 12 becomes smaller, the waveform of the reverse voltage generated in the U-phase in-phase coil group 54 and the waveform of the reverse voltage generated in the U-phase in-phase coil group 55 can become closer to each other.

Thus, according to the configuration of the present example embodiment, it is possible to suppress flow of the circulating current in the circuits of the U-phase in-phase coil groups 54 and 55 connected in parallel to each other when the rotor 2 rotates. However, it is possible to reduce the torque ripple generated in the motor 1.

In particular, in the radius r2 of curvature of the salient pole outer circumferential surface 23a, when r1<r2<2×r1 is satisfied, it is possible to further reduce magnetic imbalance between the rotor 2 and the stator coil 52. However, as the radius r2 of curvature of the salient pole outer circumferential surface 23a is set within the above-described range, it is possible to further reduce the torque ripple generated in the motor 1.

In contrast, as the salient pole portion 23 according to the present example embodiment is provided with the salient pole tapered portion 23b, in the salient pole portion 23, since the magnetic flux concentrates and flows in a central portion of the rotor core 11 in the circumferential direction, the magnetic flux density of the salient pole portion 23 can be increased. Accordingly, in the rotor 2, a difference between the magnetic flux densities of the salient pole portion 23 and the rotor magnet 12 can be further reduced.

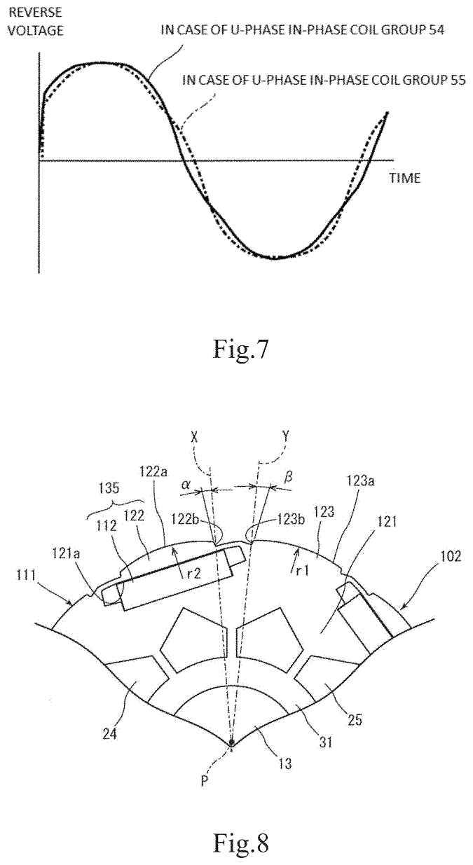

FIG. 7 is a diagram illustrating waveforms of reverse voltages generated in the stator coils 52a of the U-phase in-phase coil groups 54 and 55 when the rotor 2 rotates in a case where the salient pole portion 23 is provided with the salient pole tapered portion 23b. Similarly to the case of FIG. 5, the waveforms of the reverse voltages illustrated in FIG. 7 are results obtained when the radius of curvature of the salient pole outer circumferential surface 23a of the salient pole portion 23 is equal to the radius of curvature of the magnetic pole outer circumferential surface 12a of the magnetic pole portion 35.

As illustrated in FIG. 7, when the salient pole tapered portion 23b is provided in the salient pole portion 23, the waveform (a broken line of the drawing) of the reverse voltage generated in the U-phase in-phase coil group 55 is greatly different from the waveform (a solid line of the drawing) of the reverse voltage generated in the U-phase in-phase coil group 54.

In contrast, as the salient pole tapered portion 23b is provided in the salient pole portion 23, in the rotor 2, it is possible to further reduce a difference between the magnetic flux densities generated in the salient pole portion 23 and the rotor magnet 12. Accordingly, as illustrated in FIG. 5, the waveform of the reverse voltage generated in the U-phase in-phase coil group 54 is different from a waveform of the reverse voltage generated in the U-phase in-phase coil group 55.

However, as the salient pole tapered portion 23b is provided in the salient pole portion 23 according to the present example embodiment, when the rotor 2 rotates, it is possible to certainly suppress flow of a circulating current in circuits of the U-phase in-phase coil groups 54 and 55 connected in parallel to each other. Thus, it is possible to further reduce the torque ripple generated in the motor 1.

As described above, in the motor 1 according to the present example embodiment, the rotor 2 includes the cylindrical rotor core 11 having the plurality of salient pole portions 23 on the outer circumferential surface and extending along the central axis P and the magnetic pole portions 35 having the rotor magnets 12 alternately arranged with the salient pole portions 23 in the circumferential direction of the rotor core 11 on the outer circumferential surface of the rotor core 11. The salient pole portions 23 correspond to one magnetic pole of the rotor 2, and the magnetic pole portions 35 correspond to the other magnetic pole of the rotor 2. The salient pole portion 23 has an arc-shaped salient pole outer circumferential surface 23a protruding radially outward, in the cross section perpendicular to the central axis P. The magnetic pole portion 35 has an arc-shaped magnetic pole outer circumferential surface 12a protruding radially outward, in the cross section. In the cross section, the salient pole outer circumferential surface 23a has a larger radius of curvature than the magnetic pole outer circumferential surface 12a.

With the above configuration, in the so-called consequent-pole motor in which the rotor magnets 12 are alternately arranged with the salient pole portions 23 provided in the rotor core 11, it is possible to reduce a difference between the magnetic flux density of the magnetic flux interlinked with the stator coil 52 from the salient pole portion 23 and the magnetic flux density of the magnetic flux interlinked with the stator coil 52 from the rotor magnet 12. Thus, it is possible to reduce magnetic imbalance generated between the salient pole portion 23 and the stator coil 52 and between the rotor magnet 12 and the stator coil 52.

However, when the motor 1 is driven, the waveforms of the reverse voltages generated in the in-phase stator coils 52 can be brought closer to each other. Thus, it is possible to reduce the torque ripple generated in the motor 1.

In the above-described configuration, the length of the salient pole outer circumferential surface 23a in the circumferential direction is larger than the length of the magnetic pole outer circumferential surface 12a in the circumferential direction. Accordingly, since the salient pole outer circumferential surface 23a can be brought closer to the stator coil 52 in a wider range, it is possible to further increase the magnetic flux density of the magnetic flux interlinked with the stator coil 52 from the salient pole portion 23. However, it is possible to reduce magnetic imbalance generated between the salient pole portion 23 and the stator coil 52 and between the rotor magnet 12 and the stator coil 52.

In the above-described configuration, the salient pole portion 23 has the salient pole tapered portion 23b at at least one end portion in the circumferential direction, in which in the cross section perpendicular to the central axis P, the outer circumferential surface of the salient pole portion 23 is linearly inclined radially inward as the salient pole portion 23 goes from the center to the outer side in the circumferential direction.

With the above-described configuration, it is possible to increase the magnetic flux density generated in the center portion of the salient pole portion 23 in the circumferential direction. Accordingly, it is possible to cause the magnetic flux density generated in the salient pole portion 23 to be closer to the magnetic flux density generated in the rotor magnet 12. Thus, it is possible to reduce variations in the magnetic flux densities generated in the salient pole portion 23 and the rotor magnet 12, respectively.

However, when the motor 1 is driven, the waveforms of the reverse voltages generated in the in-phase stator coils 52 can be brought closer to each other. Thus, it is possible to suppress flow of the circulating current in a circuit including the stator coils 52. However, it is possible to reduce the torque ripple generated in the motor 1.

In the present example embodiment, since the salient pole portion 23 has the salient pole tapered portions 23b at both end portions of the rotor core 11 in the circumferential direction in the cross section perpendicular to the central axis P, the magnetic flux density generated in the central portion of the salient pole portion 23 in the circumferential direction can be increased. Thus, it is possible to further reduce variations in the magnetic flux densities generated in the salient pole portion 23 and the rotor magnet 12. However, it is possible to further reduce the torque ripple generated in the motor 1.

In the above-described configuration, in the cross section perpendicular to the central axis P, the rotor magnet 12 has magnetic pole tapered portions 12b at both end portions of the rotor core 11 in the circumferential direction, in which the outer surfaces of the rotor magnet 12 are inclined radially inward of the rotor core 11 as it goes from a center to an outer side of the rotor magnet 12 in the circumferential direction. An inclination of the salient pole tapered portion 23b with respect to the reference line Y passing through an outer end in the circumferential direction at an end portion of the salient pole portion 23 and extending in the radial direction is larger than an inclination of the magnetic pole tapered portion 12b with respect to the reference line X passing through an outer end in the circumferential direction at an end portion of the rotor magnet 12 and extending in the radial direction.

Accordingly, it is possible to cause the magnetic flux density generated in the salient pole portion 23 to be closer to the magnetic flux density generated in the rotor magnet 12. Thus, it is possible to further reduce variations in the magnetic flux densities generated in the salient pole portion 23 and the rotor magnet 12, respectively. However, it is possible to more certainly reduce the torque ripple generated in the motor 1.

With the above-described configuration, in the rotor magnet 12, in the cross section, the outer circumferential side in the radial direction has an arc shape constituting the magnet pole outer circumferential surface 12a. Accordingly, an interval between the rotor magnet 12 and the stator coil 52 can be further narrowed. However, it is possible to increase the magnetic flux density of the magnetic flux interlinked with the stator coil 52 from the rotor magnet 12. Thus, output characteristics of the motor can be improved.

In the above-described configuration, the rotor magnet includes neodymium. In the case of the rotor magnet 12 including neodymium, the above-described configurations are particularly effective.

In the above-described configuration, the stator coil 52 of the stator 3 includes a plurality of in-phase coil groups 54 and 55 in which the plurality of stator coils 52a connected in phase and in series to each other are arranged in the circumferential direction of the stator 3, in the cross section perpendicular to the central axis P. In the plurality of in-phase coil groups 54 and 55, the in-phase coil groups 54 and 55 including the in-phase stator coils 52a are connected in parallel to each other.

In the consequent-pole motor, in a case where the in-phase coil groups 54 and 55 in which the plurality of in-phase stator coils 52a of the stator 3 are arranged in the circumferential direction are connected in parallel to each other, when the rotor 2 rotates, the salient pole portion 23 or the magnetic pole portion 35 penetrates the plurality of in-phase stator coils 52a. In the plurality of in-phase stator coils 52a, when a magnetic force output from the rotor 2 differs between the salient pole portion 23 and the rotor magnet 12, the reverse voltage generated in the plurality of in-phase state coils 52a when the rotor 2 rotates differs depending on positions of the stator coils 52a of the stator 3. Then, in a configuration in which the in-phase coil groups 54 and 55 are connected in parallel to each other, the circulating current is generated in the circuit. Accordingly, the torque ripple is generated in the motor 1.

In contrast, by applying the above-described configuration, the magnetic flux density generated in the salient pole portion 23 becomes closer to the magnetic flux density generated in the rotor magnet 12, so that it is possible to suppress a deviation of the waveform of the reverse voltage generated in the plurality of in-phase stator coils 52a. Thus, it is possible to suppress generation of the torque ripple in the motor 1.

Hereinafter, although the example embodiment of the present disclosure has been described, the above-described example embodiment is merely an example for implementing the present disclosure. Thus, the present disclosure is not limited to the above-described example embodiment, and the above-described example embodiment can be appropriately modified and implemented without departing from the spirit of the disclosure.

In the example embodiment, the motor 1 is a so-called SPM motor in which the rotor magnets 12 are disposed on the outer circumferential surface of the rotor core 11. However, the motor may be an interior permanent magnet (IPM) motor in which the rotor magnet is disposed inside the rotor core.

A stator of the IPM motor has the same configuration as the stator 3 of the motor 1 illustrated in FIG. 1. Thus, hereinafter, a configuration of a rotor of the IPM motor will be described. An example of a configuration of a rotor 102 of the IPM motor is illustrated in FIG. 8. Hereinafter, configurations similar to those of the motor 1 illustrated in FIG. 1 are denoted by the same reference numerals, and description thereof will be omitted.

As illustrated in FIG. 8, the rotor 102 includes a rotor core 111, a rotor magnet 112, and the rotary shaft 13.

Similar to the rotor core 11 illustrated in FIG. 1, the rotor core 111 has a cylindrical shape extending along the central axis P. Further, the rotor core 111 is also formed by laminating a plurality of electromagnetic steel plates formed in a predetermined shape in a thickness direction.

The rotor core 111 has a core portion 121 and a ring portion 31. The core portion 121 and the ring portion 31 have cylindrical shapes. The ring portion 31 penetrates the rotary shaft 13. The first space 24 and the second space 25 similar to the configuration illustrated in FIG. 1 are partitioned by the core portion 121. That is, similar to the rotor core 11 illustrated in FIG. 1, the rotor core 111 has the first space 24 and the second space 25.

The core portion 121 has a plurality of protrusion portions 122 and a plurality of salient pole portions 123 on an outer circumferential surface. The plurality of protrusion portions 122 and the plurality of salient pole portions 123 protrude radially outward of the core portion 121 in a predetermined range in a circumferential direction of the outer circumferential surface of the core portion 121, in the cross section perpendicular to the central axis P. The protrusion portions 122 and the salient pole portions 123 are alternately arranged in the circumferential direction of the core portion 121.

The core portion 121 has an accommodation space 121a in which the rotor magnet 112 is accommodated radially inward of the core portion 121 with respect to the protrusion portion 122, in the cross section perpendicular to the central axis P. The accommodation space 121a has a rectangular cross section that is long in the circumferential direction of the core portion 121, in the cross section. The rotor magnet 112 has a rectangular parallelepiped shape, which can be disposed inside the accommodation space 121a.

In a state in which the rotor magnet 112 is disposed inside the rotor core 111, in the cross section, a radially outer surface of the rotor core 111 may have an arc shape. Further, in the cross section, the rotor magnet 112 may have a curved shape in which the radially outer and inner surfaces of the rotor core 111 have arc shapes. In the cross section, it is preferable that a sectional shape of the accommodation space 121a is matched with a sectional shape of the rotor magnet 112.

In a state in which the rotor magnet 112 is disposed inside the accommodation space 121a of the rotor core 111, the rotor magnet 112 and the protrusion portion 122 constitute a magnetic pole portion 135.

The first space 24 is located radially inward of the core portion 121 with respect to the salient pole portion 123 in the cross section perpendicular to the central axis P. The second space 25 is located radially inward of the core portion 121 with respect to the rotor magnet 112, in the cross section.

The protrusion portion 122 and the salient pole portion 123 have arc-shaped magnetic pole outer circumferential surfaces 122a and arc-shaped salient pole outer circumferential surfaces 123a protruding radially outward of the rotor core 111, in the cross section perpendicular to the central axis P, respectively. The radius r2 of curvature of the salient pole outer circumferential surface 123a is larger than the radius r1 of curvature of the magnetic pole outer circumferential surface 122a.

The salient pole portion 123 has salient pole tapered portions 123b at both end portions of the rotor core 111 in the circumferential direction, in which in the cross section perpendicular to the central axis P, the outer surfaces of the salient pole portion 123 are linearly inclined radially inward of the rotor core 11 as the salient pole portion 123 goes from a center to an outer side in the circumferential direction. As the salient pole tapered portion 123b is provided in the salient pole portion 123, an interval in the circumferential direction between the salient pole portion 123 and the protrusion portion 122 located next to the salient pole portion 123 in the circumferential direction becomes larger as the salient pole portion 123 and the protrusion portion 122 go toward the outside in the radial direction. The salient pole tapered portion 123b has planar surfaces provided on the both end portions of the salient pole portion 123 in the circumferential direction and on an outer circumferential side in the radial direction.

As illustrated in FIG. 8, similar to the salient pole portion 123, the protrusion portion 122 has salient pole tapered portions 122b at both end portions of the rotor core 111 in the circumferential direction, in which in the cross section, the outer surfaces of the salient pole portion 123 are inclined radially inward of the rotor core 11 as the salient pole portion 123 goes from a center to an outer side in the circumferential direction.

In the cross section perpendicular to the central axis P, the magnetic pole tapered portion 122b is inclined at the angle α with respect to the reference line X passing through an outer end (a portion located on an outermost side in the circumferential direction) of the magnetic pole portion 35 in the circumferential direction and extending radially from the rotor core 11.

In the cross section, the salient pole tapered portion 123b is inclined at an angle β with respect to a reference line Y passing through an outer end of the salient pole portion 123 in the circumferential direction and extending radially from the rotor core 111. The angle β of the salient pole tapered portion 123b is larger than the angle α of the magnetic pole tapered portion 122b provided in the protrusion portion 122. That is, an inclination of the salient pole tapered portion 123b with respect to the reference line Y is larger than an inclination of the magnetic pole tapered portion 122b with respect to the reference line X.

Even in the IPM motor having the above-described configuration, as the salient pole outer circumferential surface 123a having the radius r2 of curvature that is larger than the radius r1 of curvature of the magnetic pole outer circumferential surface 122a of the magnetic pole portion 135 is provided in the salient pole portion 123, it is possible to reduce magnetic imbalance between the rotor 102 and the stator core 52. However, when the rotor 102 rotates, the waveforms of the reverse voltages generated in the in-phase stator coils can be brought closer to each other. Thus, it is possible to reduce the torque ripple generated in the motor.

Moreover, the salient pole tapered portion 123b is provided in the salient pole portion 123, so that the magnetic pole density generated at a central portion of the salient pole portion 123 in the circumferential direction can be increased. Accordingly, it is possible to cause the magnetic flux density of the magnetic flux generated in the salient pole portion 123 to be closer to the magnetic flux density of the magnetic flux generated in the magnetic pole portion 135. Thus, when the rotor 102 rotates, the waveforms of the reverse voltages generated in the in-phase stator coils can be brought closer to each other. However, it is possible to further reduce the torque ripple generated in the motor.

In the above-described example embodiment, in the motor 1, the number of magnetic poles of the rotor 2 is 10, and the number of slots of the stator 3 is 12. However, the motor to which the configuration of the above-described example embodiment is applied is not limited to the above-described configuration, and other configurations may be adopted. For example, a configuration of example embodiments such as a motor in which the number of magnetic poles of the rotor is 14 and the number of slots of the stator is 12, a motor in which the number of magnetic poles of the rotor is 14 and the number of slots of the stator is 18, and a motor in which the number of magnetic poles of the rotor is 16 and the number of slots of the stator is 18 may be applied. That is, the configuration of the example embodiment may be applied to a motor which includes a plurality of in-phase coil groups in which a plurality of coils connected in phase or in series to each other are arranged in the circumferential direction of the stator and in which in-phase coil groups including in-phase coils are connected in parallel to each other.

In the present example embodiment, the salient pole portion 23 has salient pole tapered portions 23b at both end portions of the rotor core 11 in the circumferential direction, in the cross section perpendicular to the central axis P. However, the salient pole portion 23 may have the salient pole tapered portions 23b at one end portion among both end portions of the rotor core 11 in the circumferential direction, in the cross section. In this case, the reference line Y is a line passing through an outer end on an end portion side where the salient pole tapered portion 23b is provided among the both end portions of the salient pole portion 23 in the circumferential direction, in the cross section, and extending radially from the rotor core 11.

In the present example embodiment, the rotor magnet 12 has magnetic pole tapered portions 12b at both end portions of the rotor core 11 in the circumferential direction, in the cross section perpendicular to the central axis P. However, the rotor magnet 12 may have the magnetic pole tapered portion 12b at one end portion among the both end portions of the rotor core 11 in the circumferential direction, in the cross section. Further, the rotor magnet 12 may have no magnetic pole tapered portion 12b. In the cross section, when the magnetic pole tapered portion 12b is provided at one end portion among the both end portions of the rotor core 11 in the circumferential direction, the reference line X is a line passing through an outer end on an end portion side where the magnetic pole tapered portion 12b is provided among the both end portions of the salient pole portion 23 in the circumferential direction and extending in the radial direction of the rotor core 11.

In the present example embodiment, the stator coils 52 are connected to each other as illustrated in FIG. 3. However, in a combination other than that of FIG. 3, an in-phase coil group is configured by connecting in-phase stator coils in series to each other, and the in-phase coil groups are connected in parallel to each other.

In the present example embodiment, in the cross section perpendicular to the central axis P of the rotor core 11, the first space 24 and the second space 25 of the rotor core 11 are pentagonal spaces surrounded by the core portion 21. However, a first space and a second space may have shapes other than the pentagonal shape in the cross section. The first space and the second space are surrounded by, for example, a curved surface. Further, the first space and the second space may have different shapes and sizes in the cross section. The first space and the second space may be connected to each other.

In the present example embodiment, the first space 24 and the second space 25 of the rotor core 11 are alternately arranged in the circumferential direction of the rotor core 11, and a center of the first space 24 and a center of the second space are located in the circumferential direction at regular intervals. However, in the first space 24 and the second space 25, the center of the first space 24 and the center of the second space 25 may not be arranged at regular intervals.

In the present example embodiment, the rotor core 11 has the first space 24 and the second space 25. However, the rotor core 11 may further have a slit extending in the radial direction of the rotor core 11 from the first space 24 in the salient pole portion 23. In the cross section perpendicular to the central axis P of the rotor core 11, the slit may extend from the first space 24 to an outer circumferential surface of the salient pole portion 23 and may be open to the outer circumferential surface.

In the present example embodiment, the motor 1 is an inner rotor-type motor in which the columnar rotor 2 is rotatably disposed in the cylindrical stator 3. However, the motor may be an outer rotor-type motor in which the cylindrical stator is disposed in the cylindrical rotor. Even in this case, in the cross section perpendicular to the central axis of the motor, as the radius of curvature of the arc-shaped salient pole outer surface of the salient pole portion protruding radially inward from the core portion of the cylindrical rotor core becomes larger than the radius of curvature of the arc-shaped magnetic pole outer surface of the magnetic pole portion protruding radially inward from the core portion, the same effects as the effects of the example embodiment are obtained. In the above-described case, when the salient pole tapered portion is provided in the salient pole portion, in the cross section perpendicular to the central axis of the salient pole portion, the salient pole tapered portion is provided at at least one end portion in the circumferential direction of the salient pole portion. Thus, in the salient pole tapered portion, in the cross section, the outer surface of the salient pole portion is linearly inclined radially outward of the rotor core (on a base end side of the salient pole portion) as the salient pole portion goes from a center to an outer side in the circumferential direction.

The present disclosure can be used for a motor having a rotor in which rotor magnets and salient pole portions are alternately arranged on an outer surface thereof.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12. A rotor comprising:
a rotor core in a cylindrical shape that includes a plurality of salient pole portions protruding in a radial direction and extends along a central axis; and
a plurality of magnetic pole portions each including a rotor magnet and alternately arranged with the salient pole portions in a circumferential direction of the rotor core on a surface or a radially inner side of the rotor core; wherein
the salient pole portions correspond to one magnetic pole of the rotor;
the magnetic pole portions correspond to another magnetic pole of the rotor;
each of the salient pole portions includes, in a cross-section perpendicular to the central axis, a salient pole outer surface in an arc shape protruding in the radial direction;
each of the magnetic pole portions includes, in the cross section, a magnetic pole outer surface in an arc shape protruding in the radial direction; and
the salient pole outer surface includes, in the cross section, a radius of curvature larger than a radius of curvature of the magnetic pole outer surface.

13. The rotor according to claim 12, wherein
a length of the salient pole outer surface in the circumferential direction is larger than a length of the magnetic pole outer surface in the circumferential direction.

14. The rotor according to claim 12, wherein each of the salient pole portions includes, in the cross section, a salient pole tapered portion at at least one end portion in the circumferential direction, where the outer surface of the salient pole portion is linearly inclined toward a base end side of the salient pole portion from a center to an outer side of the salient pole portion in the circumferential direction.

15. The rotor according to claim 14, wherein the salient pole portion includes the salient pole tapered portion at each of both end portions in the circumferential direction, when viewed from the cross section.

16. The rotor according to claim 14, wherein
each of the magnetic pole portions includes, in the cross section, a magnetic pole tapered portion at at least one end portion in the circumferential direction, where the outer surface of the magnetic pole portion is inclined toward a base end side of the magnetic pole portion from a center to an outer side of the magnetic pole portion in the circumferential direction; and
an inclination of the salient pole tapered portion with respect to a reference line passing through an outer end in the circumferential direction at the at least one end portion of the salient pole portion and extending in the radial direction is larger than an inclination of the magnetic pole tapered portion with respect to a reference line passing through an outer end in the circumferential direction at the at least one end portion of the magnetic pole portion and extending in the radial direction.

17. The rotor according to claim 12, wherein the rotor magnet is disposed on the outer circumferential surface of the rotor core.

18. The rotor according to claim 17, wherein in the rotor magnet, in the cross section, an outer circumferential side in the radial direction has an arc shape defining the magnetic pole outer surface.

19. The rotor according to claim 12, wherein the rotor magnet is disposed radially inward of the rotor core and has a rectangular shape in the cross section.

20. The rotor according to claim 12, wherein the rotor magnet includes neodymium.

21. A motor comprising the rotor according to claim 12.

22. The motor according to claim 21, further comprising:
a stator in a columnar or cylindrical shape radially disposed to face the rotor and including a plurality of coils; wherein
in the cross-section, the plurality of coils include a plurality of in-phase coil groups in which the plurality of coils connected in phase and in series to each other are arranged in the circumferential direction of the stator; and
in the plurality of in-phase coil groups, in-phase coil groups including in-phase coils are connected in parallel to each other.
